(19) United States
(12) Patent Application Publication
(10) Pub. No.: US 2018/0361786 A1
(43) Pub. Date: Dec. 20, 2018

(54) Wheel bearing unit

(71) Applicant: Schaeffler Technologies AG & Co. KG, Herzogenaurach (DE)

(72) Inventors: Matthias Stahl, Schweinfurt (DE); Natalie Treubert, Röthlein (DE); Frank Eichelmann, Donnersdorf (DE)

(73) Assignee: Schaeffler Technologies AG & Co. KG, Herzogenaurach (DE)

(21) Appl. No.: 15/766,099

(22) PCT Filed: Sep. 2, 2016
(86) PCT No.: PCT/DE2016/200410

§ 371 Date: Aug. 7, 2018

(30) Foreign Application Priority Data
Nov. 2, 2015 (DE) 10 2015 014 059.0
Jan. 21, 2016 (DE) 10 2016 200 772.6

(51) Int. Cl. B60B 27/00; F16C 33/76; F16J 15/447; F16C 19/52; F16C 39/02

(52) U.S. Cl. CPC B60B 27/0073; B60B 27/001; F16C 33/767; F16J 15/4478; B60B 27/06; F16C 39/02; B60B 2380/73; B60B 2380/90; B60B 27/0005; F16C 19/522

(57) ABSTRACT

Wheel bearing units are disclosed. In one example, a wheel bearing unit includes an outer ring element and an inner ring element, between which there are arranged at least two rolling body rows. The inner ring element may have a radial flange which is fastenable to an axle body or to a wheel. A face surface, which faces toward the radial flange, of the outer ring element may have at least one projection.

### CROSS-REFERENCE TO RELATED APPLICATIONS

This application is the U.S. National Phase of PCT Appln. No. PCT/DE2016/200410 filed Sep. 2, 2016, which claims priority to DE 102015014059.0 filed Nov. 2, 2015 and to DE 102016200772.6 filed Jan. 21, 2016, the entire disclosures of which are incorporated by reference herein.

### TECHNICAL FIELD

The disclosure relates to a wheel bearing unit, such as for motor vehicles.

### BACKGROUND

Wheel bearings are composed of an outer ring and of a wheel bearing hub and of rolling bodies arranged in between. The wheel bearing hub has a radially outwardly directed wheel flange to which, for example, a wheel can be fastened. In certain driving situations, for example when driving over a pothole or against a curbstone, axial and/or radial shocks act on the wheel flange and/or on the wheel bearing hub. Said shocks have the effect that the wheel flange/wheel bearing hub moves in the direction of, and strikes, an outer ring of the wheel bearing unit. The forces that arise in the process are then introduced into the rolling bearing.

EP 2 184 181 B1 has disclosed a wheel bearing unit which has a wheel hub with a wheel flange. A rolling bearing is arranged between an outer ring and the wheel hub. In the described wheel bearing unit, damage to the rolling bearing owing to a lateral shock is avoided by a certain gap width.

### SUMMARY

The disclosure is based on the object of providing a wheel bearing unit which reduces the damage to the rolling bearing in the event of a shock acting on the wheel bearing unit and which furthermore ensures reliable sealing of the bearing.

According to the disclosure, said object is achieved by a wheel bearing unit having an outer ring element and having an inner ring element, between which there are arranged at least two rolling body rows, wherein the inner ring element has a radial flange which is fastenable to an axle body or to a wheel, wherein a face surface, which faces toward the radial flange, of the outer ring element has at least one projection.

The disclosure is based on the realization that, in certain driving situations, for example when driving over a pothole or against a curbstone, axial and/or radial shocks act on the wheel bearing unit. Said shocks have the effect that the inner ring element and/or the radial flange make contact with the outer ring element. In the wheel bearing unit according to the disclosure, a face surface, which faces toward the radial flange, of the outer ring element has at least one projection. Said projection is designed such that, in the event of an axial or radial shock of the inner ring element and/or radial flange, said projection absorbs the force that acts as a result, and dissipates said force in order to prevent damage to the rolling bearing and/or to the raceways. By contrast to the prior art, such a construction may entail higher manufacturing costs, but said construction leads overall to an increase of the service life of the wheel bearing unit.

The face surface of the outer ring element may have one or more projections which are arranged so as to be distributed over the circumference. If the outer ring element likewise has a radial flange with bores, the projection or the multiple projections may be arranged so as to be oriented correspondingly to the bores. Furthermore, the disclosure may relate to a wheel bearing unit with a row or multiple rows of rolling bodies in an X or 0 arrangement. Here, the rolling bodies may be formed with equal or different diameters and/or of a different rolling bearing type.

The at least one projection on the face surface is preferably formed as a ring segment. This means that the at least one projection extends in the circumferential direction not over the entire ring surface of the face surface, but rather extends in the circumferential direction only over a partial section of the face surface. If multiple projections are provided, these are provided on the face surface so as to be distributed in the circumferential direction. This has the advantage that the one or more projections may be provided in a manner dependent on the embodiment of the wheel bearing unit, the available structural space and the requirements.

In one refinement of the disclosure, the at least one projection forms a labyrinth seal. A separate seal is normally provided between the outer ring element and the inner ring element. Through the provision of at least one projection on the face surface of the outer ring element, an upstream labyrinth seal is thereby formed. This has the effect that the ingress of contaminants, such as for example rainwater or dust, from the outside into the bearing or to the further seal can be reduced or prevented. This construction leads overall to improved sealing performance and thus to an increase of the service life of the wheel bearing unit.

In one refinement of the disclosure, the at least one projection is formed integrally on the outer ring element. The outer ring element is formed in one piece with the at least one projection. In this way, it is possible to produce the outer ring element together with projection in one manufacturing step. In the case of this refinement, a further connection to the projection and to the outer ring element can be omitted.

In one refinement of the disclosure, the at least one projection is formed as a separate element. Here, the separate element may be attached directly or indirectly to the face surface. The separate element may for example be formed from a metal sheet. The separate element may also be formed from some other metallic or non-metallic material.

The separate element may be of bracket-like form. A bracket-like form may for example be understood to mean an L shape as viewed in cross section. Depending on requirements or the available structural space, the separate element may be attached to the inner circumference or to the outer circumference of the outer ring element, and then extends radially along the face surface of the outer ring element. The separate element may advantageously be formed as a ring which is attached to the inner circumference or to the outer circumference, and wherein the at least one projection, by a bracket shape, extends from the ring onto the face surface.

The separate element may be connected in non-positively locking, positively locking or cohesive fashion to the outer ring element. It is thereby ensured that the separate element remains in a fixed position throughout the usage duration. The type of connection is dependent on the embodiment of the separate element, that is to say for example material, shape etc.

In an alternative refinement of the disclosure, the at least one projection has a coating. The coating may serve for reducing generated noises.

### BRIEF DESCRIPTION OF THE DRAWINGS

Example embodiments of the disclosure will be presented below on the basis of six figures. In the figures:

FIG. 1 shows a longitudinal section through a wheel bearing unit according to the disclosure,

FIG. 2 is an illustration of an outer ring element of the wheel bearing unit shown in FIG. 1, as per a first embodiment,

FIG. 3 is an illustration of an outer ring element of the wheel bearing unit shown in FIG. 1, as per a second embodiment,

FIG. 4 shows a longitudinal section through a wheel bearing unit according to the disclosure as per a third embodiment,

FIG. 5 is an illustration of an outer ring element of the wheel bearing unit shown in FIG. 4, as per a third embodiment, and

FIG. 6 is an illustration of an outer ring element of the wheel bearing unit shown in FIG. 4, as per a fourth embodiment.

### DETAILED DESCRIPTION

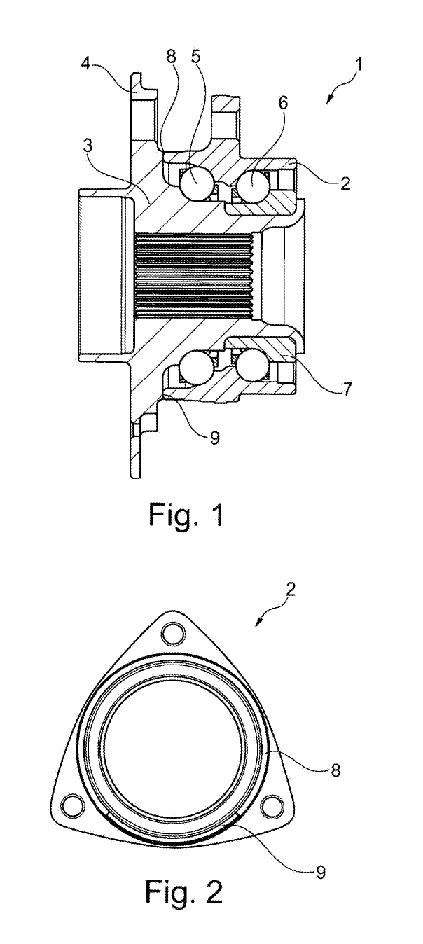

FIG. 1 shows a wheel bearing unit 1 according to one embodiment, which wheel bearing unit is assigned to a vehicle wheel (not illustrated). The wheel bearing unit 1 comprises an outer ring element 2 and an inner ring element 3. The inner ring element has a radial flange 4, which is fastenable to a wheel or axle body (not illustrated in any more detail). Furthermore, the wheel bearing arrangement has two axially spaced-apart rolling body rows 5, 6, the rolling bodies of which are guided at the outside in the outer ring element 2. At the inside, the rolling bodies of the rolling body row 5 are guided directly in a raceway of the inner ring element 3, and the rolling bodies of the rolling body row 6 are guided in an inner ring 7 fixed to the inner ring element 3.

For the more detailed explanation of a first embodiment, reference is made below to FIG. 2. A face surface 8, which faces toward the radial flange 4, of the outer ring element 2 has at least one projection 9. As can be seen in FIG. 2, the face surface 8 has a projection 9 which is formed as a ring segment. Here, the projection 9 is formed integrally, that is to say in one piece, on the outer ring element 2.

In certain driving situations, for example when driving over a pothole or against a curbstone, axial and/or radial shocks may act on the wheel bearing unit. Said shocks have the effect that the inner ring element 3 and/or the radial flange 4 make contact with the outer ring element 2. The projection 9 provided in the wheel bearing unit 1 according to the disclosure is designed such that, in the event of an axial or radial shock of the inner ring element 3 and/or radial flange 4, said projection absorbs the force that acts as a result, and dissipates said force in order to prevent damage to the rolling bearing and/or to the raceways. Here, in the event of an axial or radial shock, contact is made only with the projection 9. The disclosure is however not restricted to a single projection 9.

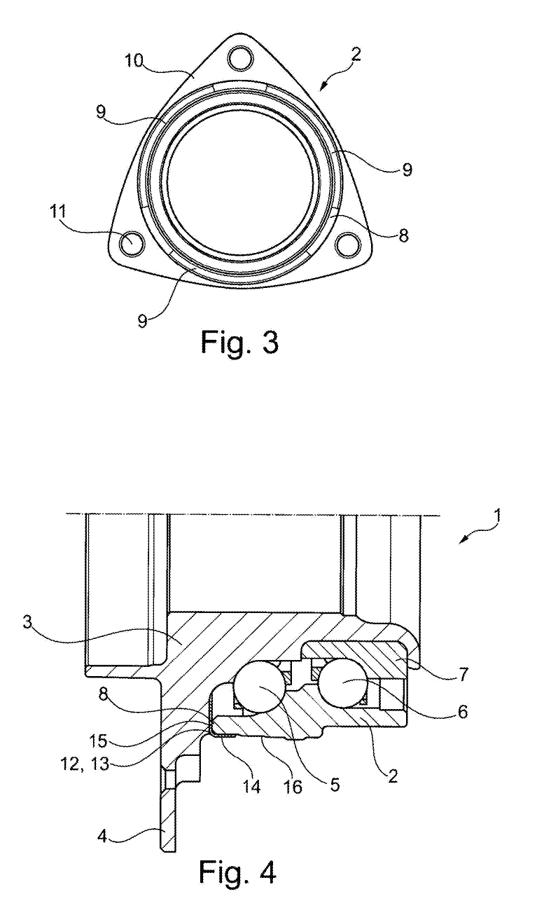

FIGS. 3 to 6 show further embodiments of the disclosure. To simplify the description, identical parts are denoted by the same reference designations as in the preceding FIGS. 1 and 2. The description is restricted only to the distinguishing features in relation to FIG. 1 and FIG. 2.

FIG. 3 is an illustration of an outer ring element 2 of the wheel bearing unit 1 shown in FIG. 1, as per a second embodiment. In this embodiment, by contrast to FIG. 2, three projections 9 are provided on the face surface 8 so as to be distributed over the circumference of the face surface 8. Said projections 9 are formed integrally on the outer ring element 2.

As can be seen from FIG. 3, the outer ring element 2 likewise has a radial flange 10 with bores 11. Here, the projections 9 are arranged so as to be oriented correspondingly between the bores 11.

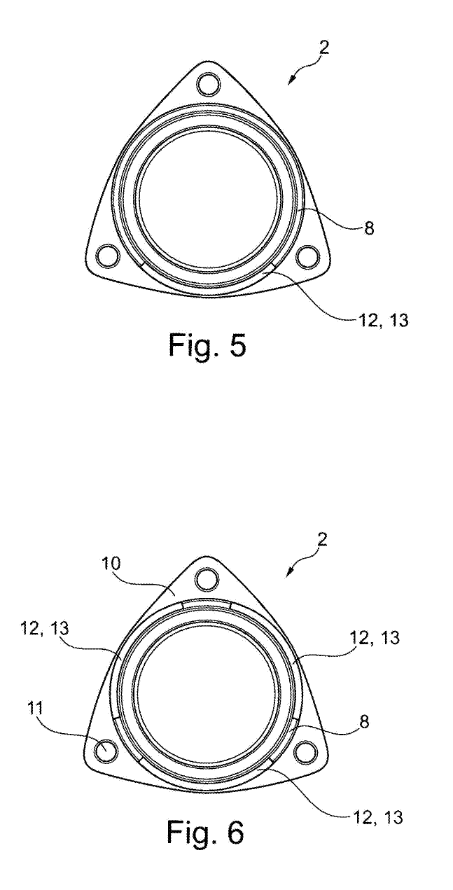

FIG. 4 shows a wheel bearing unit 1 according to a third embodiment. By contrast to the preceding embodiments, the projection 12 is formed as a separate element 13. For the more detailed explanation of the embodiment, reference is made below to FIG. 5. Here, the separate element 13 is formed from a metallic or non-metallic material, which is of bracket-like form, that is to say has an L shape in cross section. As can be seen, the separate element 13 has a first section 14 and a second section 15. Here, the first section is arranged on an outer circumference 16 of the outer element 2 and is connected to the latter. The second section 15 is assigned to the face surface 8. As can be seen from FIG. 5, the separate element 13 extends in the circumferential direction as a segmented section, and not over the entire circumference of the face surface.

Furthermore, in this embodiment, a single projection 12 is provided. The separate element 13 is connected in positively locking, non-positively locking or cohesive fashion to the outer ring element 2.

FIG. 6 is an illustration of an outer ring element 2 of the wheel bearing unit 1 shown in FIG. 4, as per a fourth embodiment. In this embodiment, by contrast to FIG. 5, three projections 12 are provided on the face surface 8 so as to be distributed over the circumference of the face surface 8. As already described in FIG. 5, said projections 9 are formed as a separate element 13.

As can be seen from FIG. 6, the outer ring element 2 likewise has a radial flange 10 with bores 11. Here, the projections 9 are arranged so as to be oriented between the bores 11.

It is also possible for the separate element 13 to be formed as a ring, and for the latter to be fastened to the outer circumference or inner circumference of the outer ring element 2. Then, a corresponding number of projections 12 formed as brackets, or one projection 12, extend(s) from the ring on the face surface 8 in accordance with the requirements.

### LIST OF REFERENCE DESIGNATIONS

1. Wheel bearing unit
2. Outer ring element
3. Inner ring element
4. Radial flange
5. Rolling body row
6. Rolling body row
7. Inner ring
8. Face surface
9. Projection
10. Radial flange
11. Bore
12. Projection
13. Separate element
14. First section
15. Second section
16. Outer circumference

1. A wheel bearing unit, comprising:
an outer ring element and an inner ring element, between which there are arranged at least two rolling body rows;
wherein the inner ring element has a radial flange which is fastenable to an axle body or to a wheel; and
wherein a face surface, which faces toward the radial flange, of the outer ring element has at least one projection.

2. The wheel bearing unit as claimed in claim 1, wherein the at least one projection on the face surface is formed as a ring segment.

3. The wheel bearing unit as claimed in claim 1, wherein the at least one projection forms a labyrinth seal.

4. The wheel bearing unit as claimed in claim 1, wherein the at least one projection is formed integrally on the outer ring element.

5. The wheel bearing unit as claimed in claim 1, wherein the at least one projection is formed as a separate element.

6. The wheel bearing unit as claimed in claim 5, wherein the separate element is of bracket-like form.

7. The wheel bearing unit as claimed in claim 5, wherein the separate element is connected in non-positively locking, positively locking, or cohesive fashion to the outer ring element.

8. The wheel bearing unit as claimed in claim 1, wherein the at least one projection has a coating.
